(19) United States
(12) Patent Application Publication
(10) Pub. No.: US 2026/0317467 A1
(43) Pub. Date: Oct. 15, 2026

(54) PRE-CROSSLINKING PROCESS, A BIO-INK COMPOSITION COMPRISING A PRE-CROSSLINKED

(71) Applicant: POLBIONICA SPOLKA Z OGRANICZONA ODPOWIEDZIALNOSCIA, Warszawa (PL)

(72) Inventors: Sylwester DOMANSKI, Warszawa (PL); Agnieszka ZAKRZEWSKA, Warszawa (PL); Oliwia JANOWSKA, Warszawa (PL); Marta KLAK, Warszawa (PL); Michal WSZOLA, Warszawa (PL)

(21) Appl. No.: 19/482,893

(22) PCT Filed: Mar. 26, 2024
(86) PCT No.: PCT/PL2024/050026

§ 371 Date: Nov. 10, 2025

(30) Foreign Application Priority Data
May 8, 2023 (EP) 23171976.6

(51) Int. Cl. C08F 222/10; B33Y 70/10; C08B 37/00; C08B 37/08; C08F 2/50; C08F 299/02; C08L 35/02; C08L 89/00

(52) U.S. Cl. CPC C08F 222/106; B33Y 70/10; C08B 37/003; C08B 37/0072; C08B 37/0084; C08F 2/50; C08F 299/028; C08L 35/02; C08L 89/00

(57) ABSTRACT

A process for pre-crosslinking methacrylates, comprising the following steps: placing in a transparent vessel an aqueous solution with a pH of 4 to 8 containing methacrylate with a molecular weight of 1 kDa to 500,000 kDa, preferably from 30 to 70 kDa, with the number of polymerizable functional groups of at least 0.5% and a concentration ranging from 0, 5 to 50% (w/v) and photoinitiator with a concentration ranging from 0.0125% to 2% (w/v), the mixture is irradiated with UVVIS radiation with a wavelength from 250 nm to 800 nm and a power from 1 to 1000 mW/cm2, for no longer than 1000 s, with the vessel being rotated 180 degrees halfway through the cross-linking time.

The invention concerns a process for pre-crosslinking low-molecular polymers by partial polymerisation with the use of UV-VIS radiation. This technology can be applied even for very fluid hydrogels that are problematic in use for bio-printing due to their mechanical properties that are manifested as an excessively liquid formula. The technology does not exclude the use of cells, that is bio-printing with a living material.

US20210046220A1 discloses a composition of hydrogel that comprises crosslinked biodegradable polymers. The composition can optionally include microgel cells crosslinked with a second agent. Paragraph [0089] states that the resulting compositions were subjected to UV radiation at ~20 mW/cm² for 1 minute to stabilise the structures produced.

U.S. Pat. No. 9,045,657B2 describes a viscoelastic ink for direct production of hydrogel structures, which includes a long chain polymer and a photopolymerizable moiety, which may be a photopolymerizable monomer or a photopolymerizable group attached to the long chain polymer. The ink may also include a crosslinking agent, a photoinitiator, and water. Paragraph [0125] states that the composition may be cured using 1 minute of UV exposure at an intensity of approximately 100 mW/cm² for 320 nm light and at an even lower intensity with 250 nm light.

EP3412728B1 discloses a microcapsule which comprises a shell that has a three-dimensional cross-linked structure containing at least one bond selected from a urethane bond or a urea bond, and a core that contains a polymerizable compound and a photopolymerization initiator. Paragraph [0511] discloses that in the irradiation step, it is advantageous to irradiate with UV light for 0.01 seconds to 120 seconds, preferably 0.1 seconds to 90 seconds.

WO2022109284A1 discloses a method of shrinking a hydrogel. The method includes contacting a polyionic hydrogel with a polyionic solution including an ionic polymer having a net opposite charge from that of the polyionic hydrogel for an amount of time sufficient to decrease the volume of the polyionic hydrogel. It also describes hydrogel compositions made using this method, and methods of using these hydrogels in 3D printing. Paragraph [0109] discloses that photocrosslinking was initiated upon UV-irradiation (approximately 10 mW/cm², 360-480 nm, 40 s).

US20220306877A1 describes methods of producing structures for 3D printing from biocompatible proteins, which comprise producing a photoreactive protein resin and 3D printing of biocompatible structures from the resin by application of light with the selected wave length to cure the resin into the desired structures. Appropriate photoreactive protein resins can be prepared by combining an aqueous solution of an acrylated or methacrylated globular protein with a photoreactive comonomer or photoinitiator. Structures printed from the photoreactive protein resin can be subjected to photo-curing and drying to produce bioplastic structures. In paragraph [0072] and in Table 4, photo-curing times are disclosed that range from 2 to 18 seconds.

WO2022233736A1 describes a radiation-curable composition comprising at least one water-soluble monofunctional unsaturated monomer, at least one water-soluble non-curable component, and at least one photoinitiator. Paragraph [0093] states that the radiation-curable fluid composition can be cured by actinic rays that have sufficient energy to initiate a polymerization or cross-linking reaction. The actinic radiation includes a-rays, g-rays, UV radiation, visible light, and electron beams, wherein UV radiation and electron beams, especially, UV radiation is preferred. Paragraph [0094] discloses that the radiation time can be in the range from 0.5 to 10 s, preferably from 0.6 to 6 s.

US20170319746A1 discloses a composition comprising two materials cross-linked in a reaction inducible by a common activator. According to paragraph [0058], in preferred compositions, the first cross-linking reaction is relatively fast, preferably in the order of about 0.1 to 10 seconds e.g. about 1 second, and the second cross-linking reaction is relatively slow, preferably in the order of about 10 to 60 minutes, e.g. about 15 to 30 minutes.

US20200255818A1 discloses a mixture for forming cross-linked polymer-encapsulated cells. The mixture comprises a pre-polymer, a photoinitiator, and cells. According to paragraph [0136], the mixture of cells, pre-polymer and photoinitiator can be cured by UV radiation to cross-link the pre-polymer. In some approaches, the curing can include UV radiation (ranging from 300 nm to 450 nm) for a time effective to cross-link the pre-polymer in order to encapsulate the cells. In some cases, the UV-curing can take less than 30 seconds, less than 15 seconds, or less than 10 seconds.

The purpose of the invention is to develop a process of preparing a material for bio-printing, which includes pre-crosslinking and which increases the viscosity of low-molecular polymer hydrogels, especially those that are water soluble. The process improves mechanical properties of a hydrogel and affects printability. With a low molecular weight and low polymer solution concentrations, 3D printing is impossible. Pre-crosslinking by partial polymerisation with the use of UV-VIS rays increases the material viscosity, which enables printing with such pre-crosslinked (PCL) polymers. The purpose of the invention is also to provide a bio-printing process using bio-ink that comprises a pre-crosslinked polymer.

The invention relates to a process of pre-crosslinking methacrylates, comprising the following steps:
placing in a transparent vessel an aqueous solution with pH 4 to 8 comprising a methacrylate with a molecular weight of 1 kDa to 500,000 kDa, preferably 30 to 70 kDa, with a number of functional groups subject to polymerisation of at least 0.5% and a concentration ranging from 0.5 to 50% (w/v), and a photoinitiator with a concentration ranging from 0.0125% to 2% (w/v),
the mixture is subjected to UV-VIS irradiation UV-VIS with a wave length of 250 nm to 800 nm and a power of 1 to 1000 mW/cm2, for a time not exceeding 1000 s, wherein the vessel is rotated by 180 degrees at half the crosslinking time.

Preferably, the methacrylates are selected from a group including GELMA, HAMA, ALGMA, CHIMA.

Preferably, the photoinitiator is selected from a group including lithium phenyl-2,4,6-trimethylbenzoylphosphine, 2-Hydroxy-1-(4-(2-hydroxyethoxy)phenyl)-2-methylpropan-1-one and its derivatives or the derivatives of diazo compounds. Preferably, the aqueous solution is a physiological salt, a cellular medium or a weak acid solution.

Preferably, the crosslinking is carried out in a syringe with a cross-section of 1 to 100 nm.

The invention further relates to a bio-ink composition comprising a pre-crosslinked methacrylate.

Preferably, the pre-crosslinked methacrylate has a conversion degree expressed as the content of converted methacrylate groups, which ranges from 0.1% to 99.9%, preferably from 40 to 60%.

Preferably, it comprises a pre-crosslinked methacrylate with a concentration of 0.5% to 50% (w/v) and a non-crosslinked methacrylate with a concentration of 0.1% to 99.9% (w/v).

Preferably, it additionally comprises L929 cells in a number of not less than 5×10⁵ per millilitre of bio-ink composition.

The invention further relates to a composition in bio-printing process.

Preferably, the printing temperature ranges from 5 to 50° C., the pressure ranges from 5 to 150 kPa, the printing speed ranges from 1 to 100 mm/s, and the needle diameter ranges from 50 to 900 μm, wherein once the printing is completed, an additional portion of UV-VIS light is applied with a wave length ranging from 280 nm to 800 nm, preferably 405 nm, for a time of 1 s to 360 s, preferably 30 s, with a power of 1 to 1000 mW/cm2, preferably 28.5 mW/cm2.

Preferably, the printing includes extrusion or volumetric printing.

An advantage of the invention is that the bio-ink composition comprising a methacrylate pre-crosslinked with the process according to the invention makes it possible to print materials that show a continuous, compact fibre, which enabled printing at a good/very good resolution, which were then additionally crosslinked after bio-printing. The produced materials show much better printability parameters compared to solutions not subjected to pre-crosslinking.

The invention is presented in the Drawing, wherein:

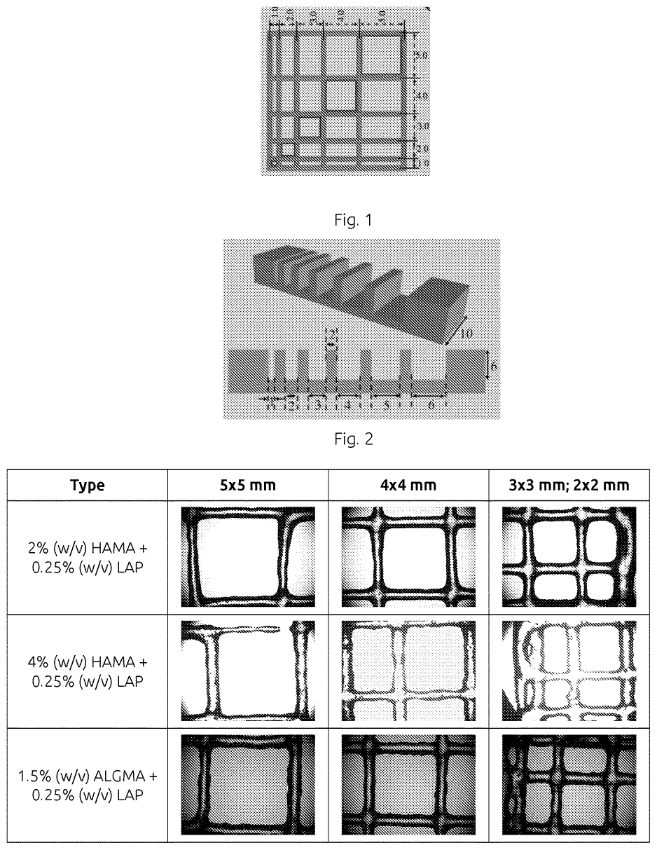

FIG. 1 shows a gcode file scheme-template.gcode

FIG. 2 shows a diagram of a fibre deflection test platform

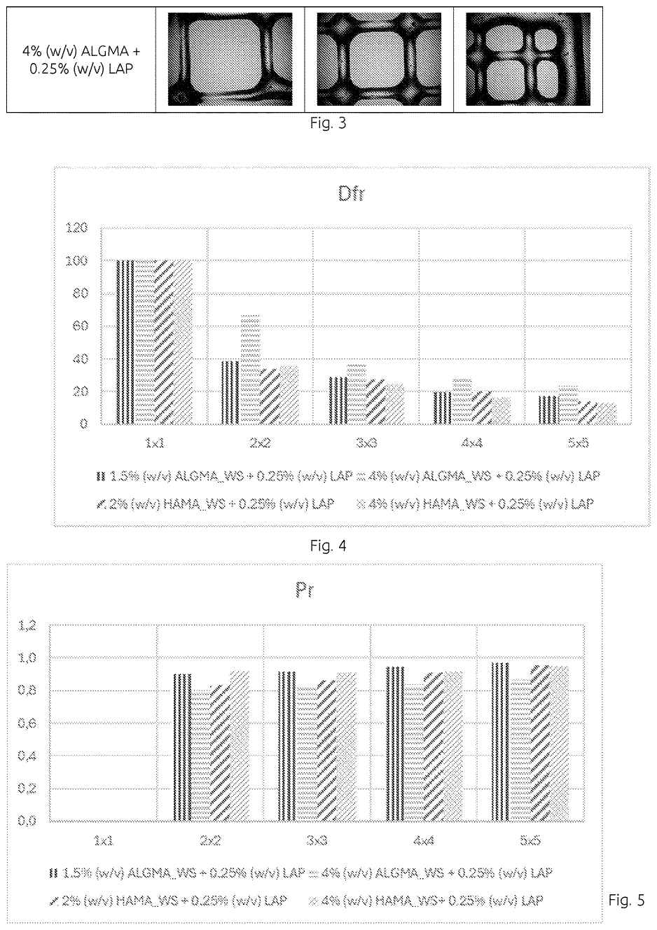

FIG. 3 shows microscope photos of the constructs in fibre bonding test

FIG. 4 shows the percent speed of fibre diffusion Dfr-fibre bonding test

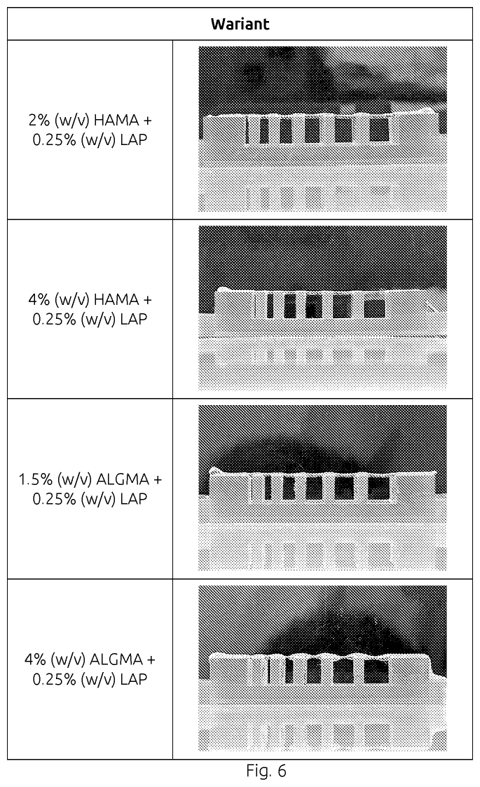

FIG. 5 shows printability Pr-fibre bonding test

FIG. 6 shows photos of the constructs in fibre deflection test

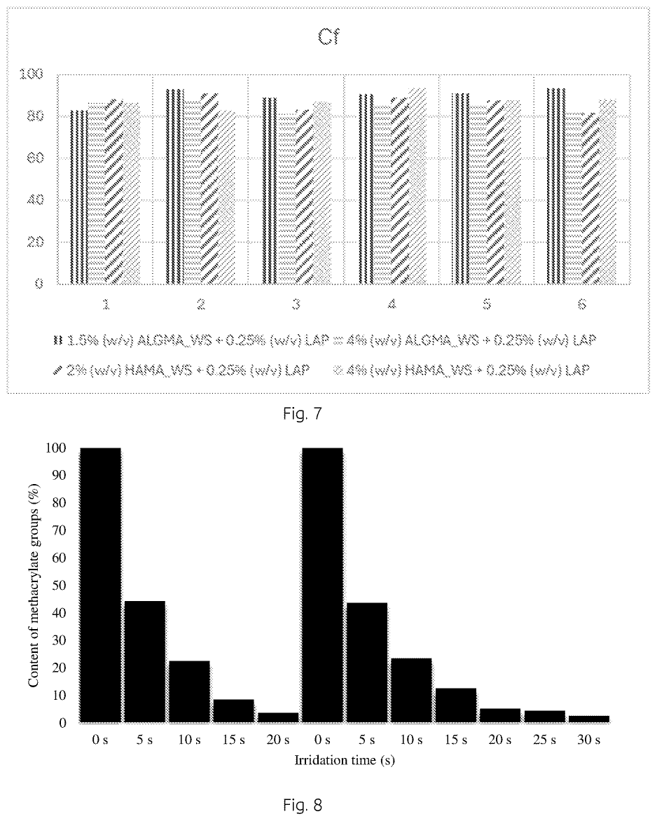

FIG. 7 shows the fibre collapse coefficient Cf-fibre deflection test

FIG. 8 shows a chart presenting the kinetics of crosslinking selected hydrogels based on HAMA

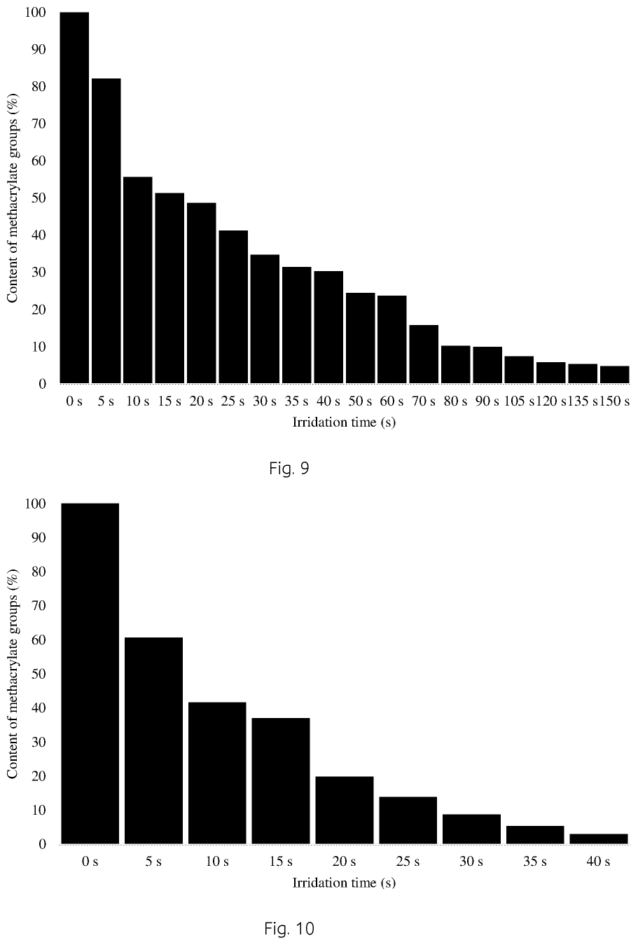

FIG. 9 shows a chart presenting the kinetics of crosslinking the hydrogel based on ALGMA

FIG. 10 shows a chart presenting the kinetics of crosslinking the hydrogel based on GELMA

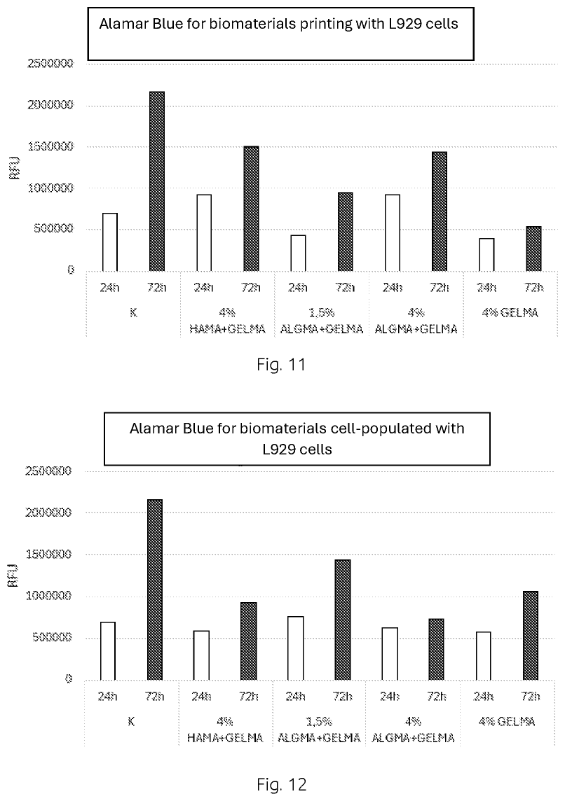

FIG. 11 shows the proliferation degree for cells subjected to printing in the tested biomaterials

FIG. 12 shows the proliferation degree for cells populated on the tested biomaterials

FIG. 13 shows observations for cells printed in biomaterial 4% ALGMA+GELMA [3% (w/v) ALGMA (low viscosity): 1% (w/v) GELMA with the addition of 0.25% (w/v) LAP] in transmitted light (BF) and after FDA/Pi colouring (green/red)

FIG. 14 shows observations for cells populated on biomaterial 2% HAMA+GELMA [1.5% (w/v) HAMA (130-300 kDa): 1% (w/v) GELMA with the addition of 0.25% (w/v) LAP] in transmitted light (BF) and after FDA/Pi colouring (green/red)

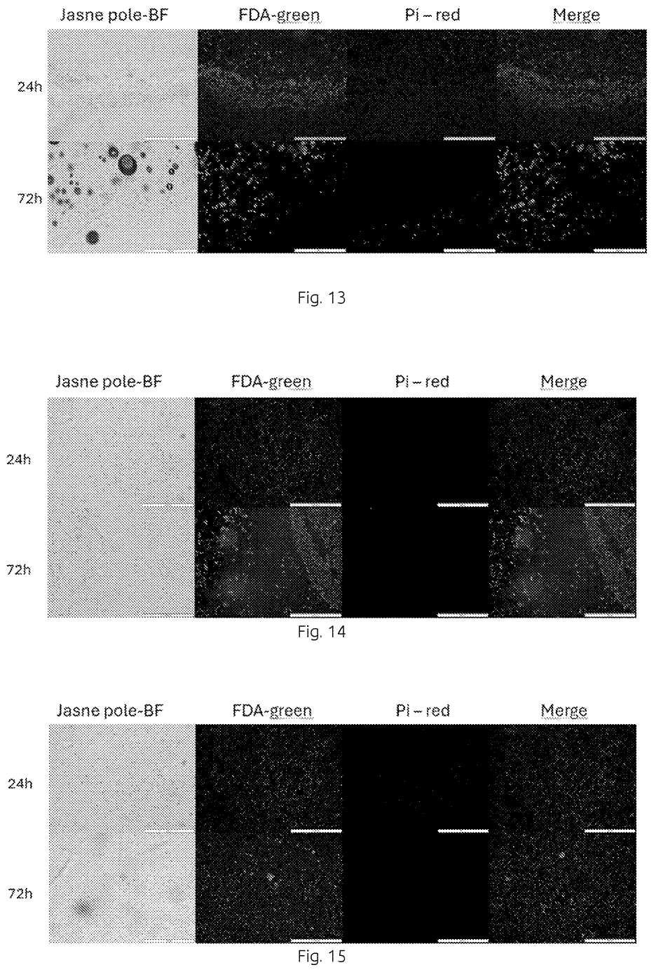

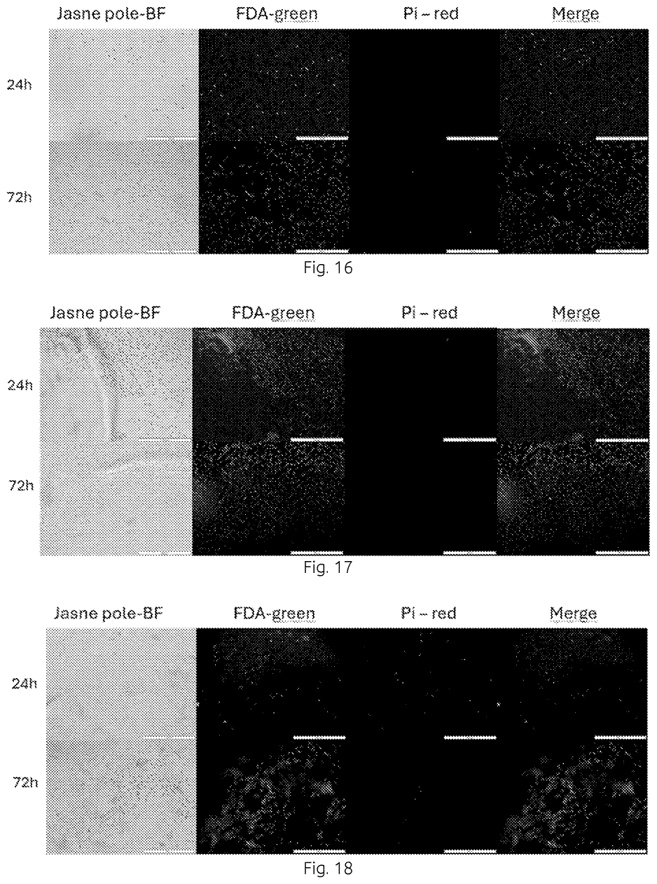

FIG. 15 shows observations for cells populated on biomaterial 4% HAMA+GELMA [3% (w/v) HAMA (30-50 kDa): 1% (w/v) GELMA with the addition of 0.25% (w/v) LAP] in transmitted light (BF) and after FDA/Pi colouring (green/red)

FIG. 16 shows observations for cells populated on biomaterial 4% ALGMA+GELMA [3% (w/v) ALGMA (low viscosity): 1% (w/v) GELMA with the addition of 0.25% (w/v) LAP] in transmitted light (BF) and after FDA/Pi colouring (green/red)

FIG. 17 shows observations for cells populated on biomaterial 4% GELMA [4% (w/v) GELMA+0.25% (w/v) LAP] in transmitted light (BF) and after FDA/Pi colouring (green/red)

FIG. 18 shows observations for cells populated on biomaterial 1.5% ALGMA+GELMA [0.75% (w/v) ALGMA (high viscosity): 1% (w/v) GELMA with the addition of 0.25% (w/v) LAP] in transmitted light (BF) and after FDA/Pi colouring (green/red)

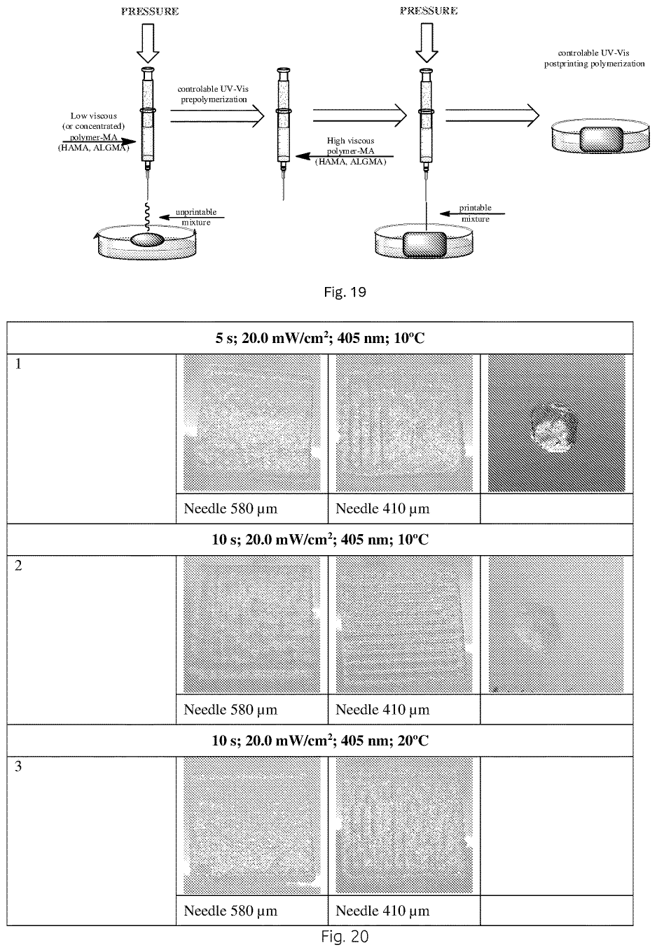

FIG. 19 shows a schematic diagram presenting the principle of operation of the pre-crosslinking technology exemplified by methacrylate derivatives of natural polymers

FIG. 20 shows the characteristics of sample printouts including photos: 1-Smooth, compact fibre, construct with a good resolution, construct could be lifted from the pan, they were not brittle, a compact and smooth drop
2—Smooth, slightly lumpy fibre, construct with a very good resolution, construct could be lifted from the pan, they were not brittle, a compact and smooth drop, small lumps visible.
3—No difference in fibre structure compared to the same parameters of pre-crosslinking at a lower printing temperature. Compact fibre, good extrusion.

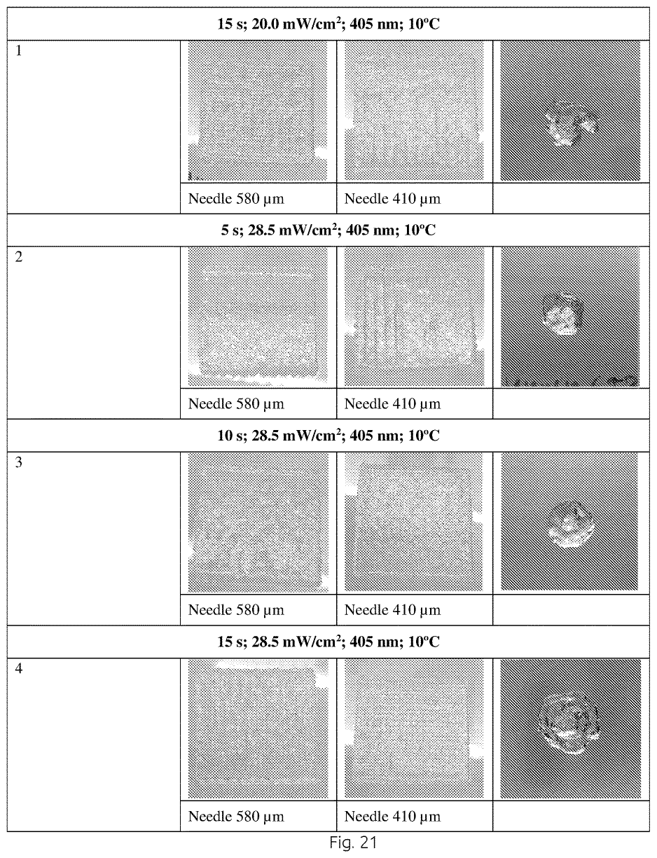

FIG. 21 shows the characteristics of printouts including photos: 1—Very compact and slightly lumpy fibre. High print resolution. Clogging of a 410 μm needle. construct could be lifted from the pan, they were not brittle. Very compact drop.
2—Smooth, slightly compact fibre, construct with a good resolution. Construct could be lifted from the pan, they were not brittle. Compact and smooth drop.
3—Compact and slightly lumpy fibre. Good print resolution. Clogging of a 410 μm needle. Construct could be lifted from the pan, they were not brittle. Very compact drop.
4—Compact and slightly lumpy fibre. Very good print resolution. Clogging of a 410 μm needle. Construct could be lifted from the pan, they were not brittle. Very compact drop.

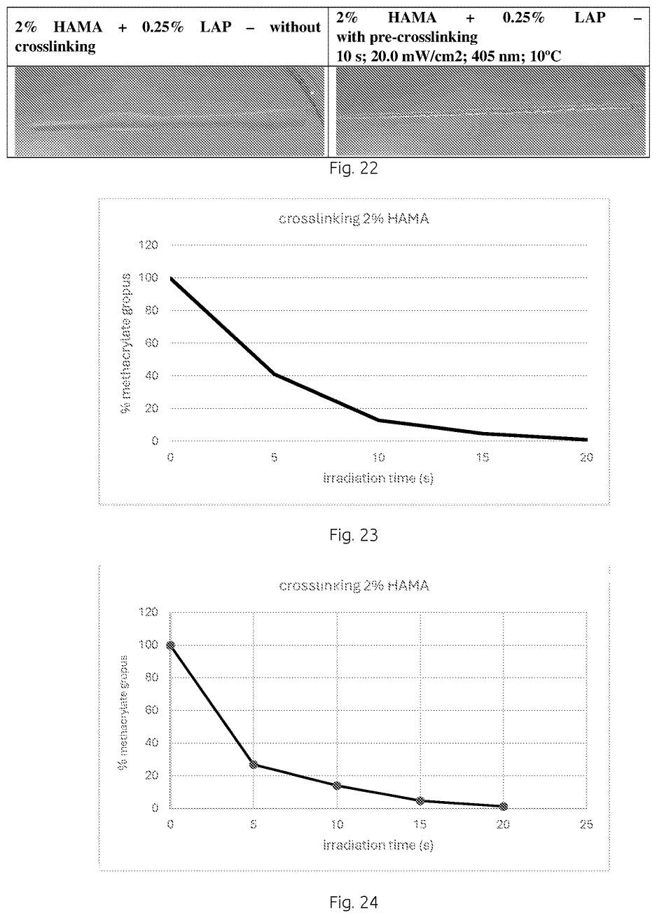

FIG. 22 shows a comparison of the quality of extruded fibres

FIG. 23 shows extinction of the signal of methacrylate groups at the path of crosslinking with 2% HAMA, 0.25% LAP, 405 nm, P=20 mW/cm2

FIG. 24 shows extinction of the signal of methacrylate groups at the path of crosslinking with 2% HAMA, 0.25% LAP, 405 nm, P=28.5 mW/cm²

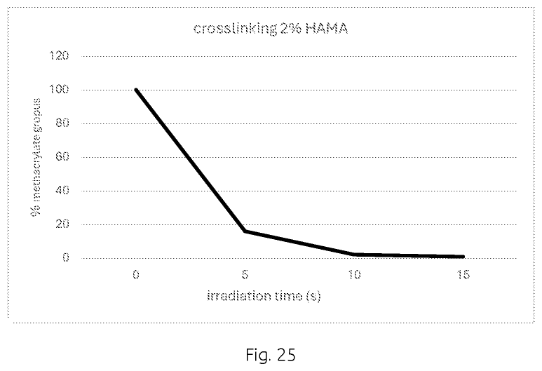

FIG. 25 shows extinction of the signal of methacrylate groups at the path of crosslinking with 2% HAMA, 0.25% LAP, 365 nm, P=13 mW/cm²

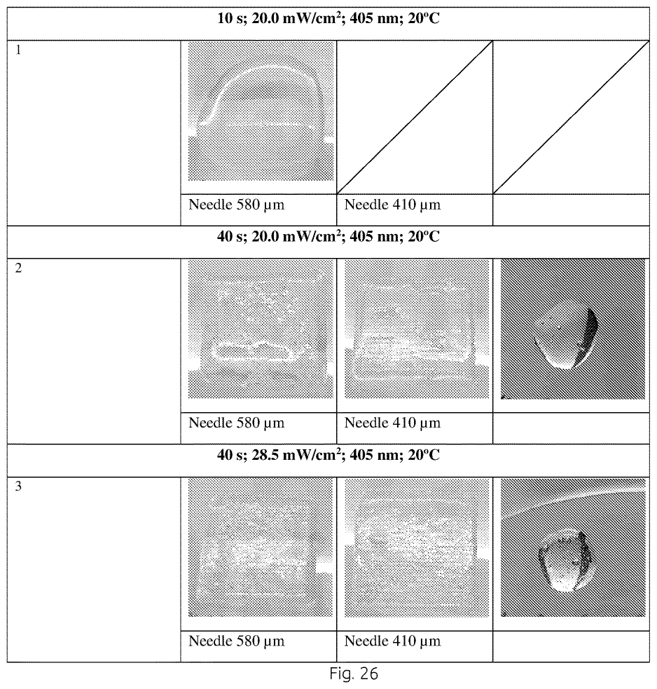

FIG. 26 shows the characteristics of printouts including photos: 1—Smooth, highly flowing fibre. Producing a good-resolution construct impossible.

2—Fibre slightly flowing but allows for producing a construct with average/good resolution. Needles not clogging. Drop slightly fluid. Construct flexible, can be taken off the pan.
3—Compact and slightly extending. Construct with a very good resolution. Needles not clogging. Compact and smooth drop. Construct flexible, can be taken off the pan.

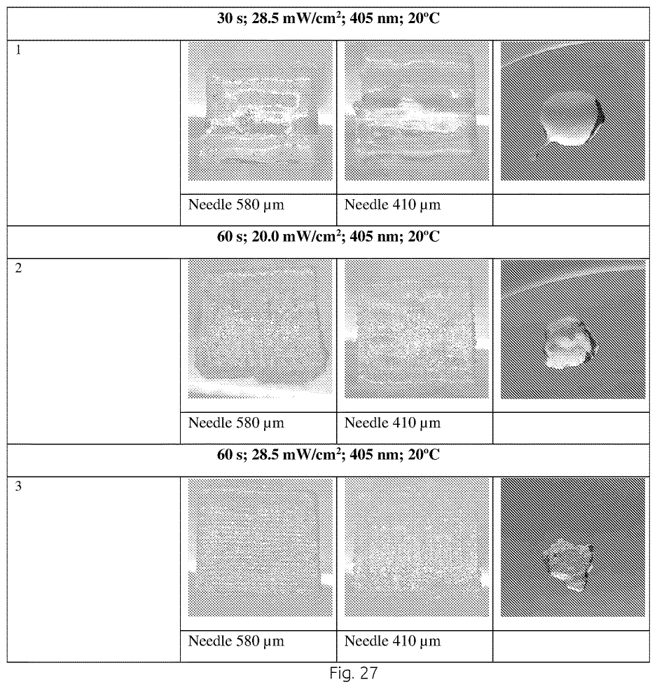

FIG. 27 shows the characteristics of printouts including photos: 1-Fibre slightly fluid but allows for producing a construct with average/good resolution. Needles not clogging. Drop slightly fluid. Construct flexible, can be taken off the pan.
2—Compact and slightly lumpy fibre, construct with a very good resolution. Needles not clogging. Construct flexible, can be taken off the pan. Compact and smooth drop.
3—Compact and slightly lumpy fibre, construct with a very good resolution. Needles not clogging. Construct flexible, can be taken off the pan. Compact and smooth drop.

The crosslinking level of the material subjected to pre-crosslinking, measured by the number of converted methacrylate groups or other groups subject to polymerisation, should range from 0.1% to 99.9%, preferably from 40 to 60%. The crosslinking parameters should be selected in such a way that the number of groups that may be polymerised is not lower than 0.5%, which allows for subsequent crosslinking to be carried out after bio-printing and full crosslinking of the material after printing, as well as for producing durable links in the construct. The whole process comprises three steps: 1. Preparing the material with the use of pre-crosslinking, which increases the viscosity of hydrogel based on methacrylates 2. Carrying out bio-printing with the use of pre-crosslinked hydrogels. 3. Crosslinking/additional crosslinking of the material after printing (after each layer) in order to produce durable links between the fibres.

The crosslinking method according to the invention can be applied to the solutions of methacrylates: GELMA (methacrylated gelatin), HAMA (methacrylated hyaluronic acid), ALGMA (methacrylated derivative of sodium alginate), CHIMA (methacrylated chitosan) and other derivatives of natural polymers in the concentration range from 0.5% to 50% and the concentration of photoinitiator (selected from the group including lithium phenyl-2,4,6-trimethylbenzoylphosphine, 2-Hydroxy-1-(4-(2-hydroxyethoxy)phenyl)-2-methylpropan-1-one and its derivatives or the derivatives of diazo compounds, complexes and transient metal salts, peroxides and halogens, and other initiators) ranging from 0.0125% to 2%, whose native form does not allow for making high-resolution 3D printouts. The materials subjected to methacrylation (or functionalisation with another substituent that allows crosslinking), respectively gelatin, hyaluronic acid, alginate, chitosan and other natural polymer derivatives with a molecular weight ranging from 1 kDa to 500000 kDa, preferably from 30 kDa to 70 kDa, which after the functionalisation show a degree of substitution within the range from 10 to 100% with a methacrylate, acrylate, styrene or another substituent including a double or triple bond that can be polymerised. This includes mixed polymerisation between the atoms of carbon, nitrogen, sulphur and other elements. The process includes work with fully soluble polymers at the concentrations of 0.1 to 100 ml in water environment, including in physiological salt solutions, cellular media designed for a particular cell line, or weak acids with a pH of 4 to 8.

The pre-crosslinking procedure requires an appropriate hydrogel solution for an open vessel or a vessel that provides appropriate penetrability of UV-VIS rays in an amount of 0.1 ml to 10 ml of any, and subject it to pre-crosslinking at 1 s to 1000 s intervals for a time necessary to give them a printable form, i.e. from 1 s to 1000 s. The wave length used for pre-crosslinking ranges from 250 nm to 800 nm. Light power ranging from 1 mW/cm² to 1000 mW/cm². The pre-crosslinking procedure is preferably carried out with the use of a transparent, cylindrical vessel with a plunger or any other vessel that allows controlling the thickness of the crosslinked layer and transferring the material to the printer head with a cross-section of 1 mm to 100 mm.

Pre-crosslinked (Pre C-L) materials can be used as a single material for bio-ink or as an additive to a mixture of other non-crosslinked materials with a concentration of 0.1% to 99.9%, as well as for pre-crosslinked materials with a concentration of 0.5% to 50%, representing 0.1% to 99.9% of the entire blend. Pre-crosslinked (PCL) materials or their blends can be applied in biological tests with the use of a reference cell line L929 at the initial stage of tests, or according to ISO 10993-5 for replaceable lines, provided that the same or similar results of MTT tests are achieved, i.e. CCL 1 (NCTC clone 929), CCL 163 (Balb/3T3 clone A31), CCL 171 (MRC-5) and CCL 75 (WI-38), CCL 81 (Vero) and CCL 10 [BHK-21 (C-13) and V-79 379A, as well as other cell lines commercially available or isolated from human or animal tissues. In particular: endothelial cells, stem cells, pancreatic islet cells (alpha, beta, delta), bone, muscle or nerve cells, and at later test stages, with the use of specific cell lines according to the application. The number of cells in 1 millilitre of bio-ink is not lower than 5×10⁵. Pre-crosslinked (PCL) materials, their blends, and materials with the addition of cell lines can be homogenised with the inter-syringe mixing technique or with specialised cell mixers dedicated for biological applications, or with other dedicated devices.

The presented technology covers extrusion and volumetric printing as well as other printing technologies that require appropriate viscosity of the material to obtain a uniform and compact fibre to maintain the print resolution. The print temperature may vary from 5° C. to 50° C. depending on the material used. The print pressure for extrusion printing ranges from 5 to 150 kPa. Print speed in the range from 1 to 100 mm/s. Needle diameter in the range from 50 to 900 μm. The printed model can have any dimensions expressed in mm as well as the filling degree of 5% to 100% to obtain an openwork printout.

### I. Preparing Solutions

1) Solution GELMA 4% (w/v)+LAP 0.25% (w/v)

We prepared 10.0 ml of solution GELMA 4% (w/v)+LAP 0.25% (w/v). Lyophilizate GELMA with a 100% substitution degree.

We moved 10.0 ml of PBS×1 by volume to a 50 ml flask using a serological pipette. We used an analytical balance to weigh out LAP on a balance vessel, and then we moved 25.0±0.5 mg of LAP by volume to a flask with PBS×1. The flask with the solution was moved to a thermoblock (30-50° C.), and then we mixed it at 100-1000 rpm for 15-30 mins (until the photoinitiator was dissolved). The we weighed out the GELMA lyophilizate and added it to the photoinitiator solution in the amount of 400.0±1.0 mg. The GELMA solution was left in the thermoblock (30-50° C.) until fully dissolved, with the mixing speed of 100-1000 rpm. Once GELMA was fully dissolved, we checked the PH of the solution, adjusting it to the range of 7.2-7.4. The prepared solution was subjected to filtration with a 0.22-0.45 μm syringe filter. The filtered solution was moved to a 50 ml flask wrapped with aluminium foil and then put in a refrigerator to be stored until use.

2) Solution HAMA 2% (w/v)+LAP 0.25% (w/v)

We prepared 10.0 ml of solution HAMA 2% (w/v)+LAP 0.25% (w/v). Hyaluronic acid with a molecular weight of 130-300 kDa, HAMA lyophilizate with a 25% substitution degree.

We moved 2.0 ml of PBS×1 to a 15 ml flask. We used an analytical balance to weigh out a LAP portion on a balance vessel, and then we moved 25.0±0.5 mg to a flask with PBS×1. The flask was wrapped with aluminium foil, moved to a thermoblock and shaken at a speed of 100-1000 rpm and a temperature of 30-50° C. Once the photoinitiator was dissolved, the flask was put in a refrigerator. We moved 8.0 ml of PBS×1 to a 50 ml flask. Then we weighed out a portion of HAMA lyophilizate that was moved accordingly to a flask with PBS×1 in the amount of 200.0±1.0 mg. The HAMA solution was shaken in the thermoblock at a speed of 100-1000 rpm and a temperature of 4-20° C. for 0.5-4 hrs. Once the lyophilizate was dissolved, a chilled LAP solution was added and left at the thermoblock for 10-30 mins to mix the components. Once the components were fully mixed, we checked the pH of the solution, adjusting it to the range of 7.2-7.4. The prepared solution was subjected to filtration with a 0.22-0.45 μm syringe filter. The filtered solution was moved to a 50 ml flask wrapped with aluminium foil and then put in a refrigerator to be stored until use.

3) Solution HAMA 4% (w/v)+LAP 0.25% (w/v)

We prepared 10.0 ml of solution HAMA 4% (w/v)+LAP 0.25% (w/v). Hyaluronic acid with a molecular weight of 30-50 kDa, HAMA lyophilizate with a 21% substitution degree.

We moved 2.0 ml of PBS×1 to a 15 ml flask. We used an analytical balance to weigh out a LAP portion on a balance vessel, and then we moved 25.0±0.5 mg to a flask with PBS×1. The flask was wrapped with aluminium foil, moved to a thermoblock and shaken at a speed of 100-1000 rpm and a temperature of 30-50° C. Once the photoinitiator was dissolved, the flask was put in a refrigerator. We moved 8.0 ml of PBS×1 to a 50 ml flask. Then we weighed out a portion of HAMA lyophilizate that was moved accordingly to a flask with PBS×1 in the amount of 400.0±1.0 mg. The HAMA solution was shaken in the thermoblock at a speed of 100-1000 rpm and a temperature of 4-20° C. for 0.5-4 hrs. Once the lyophilizate was dissolved, a chilled LAP solution was added and left at the thermoblock for 10-30 mins to mix the components. Once the components were fully mixed, we checked the pH of the solution, adjusting it to the range of 7.2-7.4. The prepared solution was subjected to filtration with a 0.22-0.45 μm syringe filter. The filtered solution was moved to a 50 ml flask wrapped with aluminium foil and then put in a refrigerator to be stored until use.

4) Solution ALGMA 1.5% (w/v)+LAP 0.25% (w/v)

We prepared 10.0 ml of solution ALGMA 1.5% (w/v)+LAP 0.25% (w/v). High-viscosity alginate, ALGMA lyophilizate with a 25% substitution degree.

We moved 10.0 ml of PBS×1 by volume to a 50 ml flask using a serological pipette. We used an analytical balance to weigh out LAP on a balance vessel, and then we moved 25±0.5 mg of LAP by volume to a flask with PBS×1. The flask with the solution was moved to a thermoblock (20-30° C.), and then we mixed it at 100-1000 rpm for 15-30 mins (until the photoinitiator was dissolved). The we weighed out the ALGMA lyophilizate and added it to the photoinitiator solution in the amount of 150.0±1.0 mg. The ALGMA solution was left in the thermoblock (20-30° C.) for 1-24 hrs until fully dissolved, with the mixing speed of 100-1000 rpm. Once ALGMA was fully dissolved, we checked the pH of the solution, adjusting it to the range of 7.2-7.4. The prepared solution was subjected to filtration with a 0.22-0.45 μm syringe filter. The filtered solution was moved to a 50 ml flask wrapped with aluminium foil and then put in a refrigerator to be stored until use.

5) Solution ALGMA 4% (w/v)+LAP 0.25% (w/v)

We prepared 10.0 ml of solution ALGMA 4% (w/v)+LAP 0.25% (w/v). Low-viscosity alginate, ALGMA lyophilizate with a 39% substitution degree.

We moved 10.0 ml of PBS×1 by volume to a 50 ml flask using a serological pipette. We used an analytical balance to weigh out LAP on a balance vessel, and then we moved 25±0.5 mg of LAP by volume to a flask with PBS×1. The flask with the solution was moved to a thermoblock (20-30° C.), and then we mixed it at 100-1000 rpm for 15-30 mins (until the photoinitiator was dissolved). The we weighed out the ALGMA lyophilizate and added it to the photoinitiator solution in the amount of 400.0±1.0 mg. The ALGMA solution was left in the thermoblock (20-30° C.) for 1-24 hrs until fully dissolved, with the mixing speed of 100-1000 rpm. Once ALGMA was fully dissolved, we checked the pH of the solution, adjusting it to the range of 7.2-7.4. The prepared solution was subjected to filtration with a 0.22-0.45 μm syringe filter. The filtered solution was moved to a 50 ml flask wrapped with aluminium foil and then put in a refrigerator to be stored until use.

### 6) Preparing Pre-Crosslinked (Pre C-L) Materials

We used a syringe with a needle to collect 1.0-3.0 ml of methacrylate solution and then sealed it with a blue protective plug. The syringe with the material inside was pre-crosslinked according to the parameters shows in Table 1. For this purpose, the syringe was placed under a Polbionica UV-Vis lamp. The material was crosslinked evenly by rotating the syringe by 180° at half the crosslinking time. After crosslinking, the syringe was protected against light by wrapping it with aluminium foil. The protected syringe was put aside for 2-5 minutes. After that time, the pre-crosslinked solution was mixed in multiple syringes-20 pushes of the plunger. The material so prepared was ready to be used directly for printing or for preparing the blends for biological tests.

TABLE 1
Parameters of crosslinking the HAMA and ALGMA solutions.

| | | | | Stabilisation |
|---|---|---|---|---|
| | | Power | Wave length | temperature |
| Variant | Time [s] | [mW/cm²] | [nm] | [°C] |
| 2% (w/v) HAMA_WS + | 5 | 28.5 | 405 | 20 |
| 0.25% (w/v) LAP | | | | |
| 4% (w/v) HAMA_WS + | 5 | 28.5 | 405 | 20 |
| 0.25% (w/v) LAP | | | | |
| 1.5% (w/v) | 20 | 28.5 | 405 | 20 |
| ALGMA_WS + 0.25% | | | | |
| (w/v) LAP | | | | |
| 4% (w/v) ALGMA_ | 20 | 28.5 | 405 | 20 |
| WS + 0.25% (w/v) LAP | | | | |

### 7) Preparing Blends for Biological Tests

A syringe with the pre-crosslinked (PCL) material was filled with an appropriate amount of GELMA (without pre-crosslinking) and a suspension of the L929 cells—for the variants with cells suspended in biomaterial. The proportions for preparing the materials are shown in Table 2. Then the components were mixed in multiple syringes until a uniform mixture was obtained-10-20 pushes of the plunger. The material so prepared was moved to a cartridge and used for printing. The produced constructs were crosslinked after each layer according to the general pattern.

TABLE 2
Proportions for preparing the materials

| | Pre- | | |
|---|---|---|---|
| | crosslinked | | L929 |
| | (PCL) | GELMA | suspen- |
| | material | solution | sion |
| Variant | [ml] | [ml] | [ml] |
| 1.5% (w/v) HAMA_WS: 1% (w/v) | 1.5 | 0.5 | — |
| GELMA + 0.25% (w/v) LAP | | | |
| 1.5% (w/v) HAMA_WS: 1% (w/v) | 1.5 | 0.5 | 0.07 |
| GELMA + 0.25% (w/v) LAP + | | | |
| L929 | | | |
| 3% (w/v) HAMA_WS: 1% (w/v) | 1.5 | 0.5 | — |
| GELMA + 0.25% (w/v) LAP | | | |
| 3% (w/v) HAMA_WS: 1% (w/v) | 1.5 | 0.5 | 0.07 |
| GELMA + 0.25% (w/v) LAP + | | | |
| L929 | | | |
| 1.125% (w/v) ALGMA_WS: 1% | 1.5 | 0.5 | — |
| (w/v) GELMA + 0.25% (w/v) LAP | | | |
| 1.125% (w/v) ALGMA_WS: 1% | 1.5 | 0.5 | 0.07 |
| (w/v) GELMA + 0.25% (w/v) | | | |
| LAP + L929 | | | |
| 3% (w/v) ALGMA_WS: 1% (w/v) | 1.5 | 0.5 | — |
| GELMA + 0.25% (w/v) LAP | | | |
| 3% (w/v) ALGMA_WS: 1% (w/v) | 1.5 | 0.5 | 0.07 |
| GELMA + 0.25% (w/v) LAP + | | | |
| L929 | | | |

### II. Printability Tests

The printability tests were carried out with a BioX CELLINK printer. The print parameters for each material are presented in Table 3. The applied parameters provided a uniform and compact fibre. The printability test procedure was carried out based on reference literature (Ahasan Habib, Venkatachalem Sathish, Sanku Mallik, Bashir Khoda, 3D Printability of Alginate-Carboxymethyl Cellulose Hydrogel Materials (Basel) 2018 Mar. 20; 11(3):454. doi: 10.3390/ma11030454).

TABLE 3
Print parameters for printability tests of pre-crosslinked materials

| | Pressure | | |
|---|---|---|---|
| | range | Temperature | Speed |
| Variant | [kPa] | [°C] | [mm/s] |
| 2% (w/v) HAMA_WS + 0.25% (w/v) LAP | 30-40 | 20 | 15 |
| 4% (w/v) HAMA_WS + 0.25% (w/v) LAP | 20-30 | 20 | 15 |
| 1.5% (w/v) ALGMA_WS + 0.25% (w/v) | 25-40 | 20 | 15 |
| LAP | | | |
| 4% (w/v) ALGMA_WS + 0.25% (w/v) LAP | 20-25 | 20 | 15 |

### 1) Fibre Bonding Test

An appropriate g-code was prepared for the fibre bonding test: template.gcode, which assumes the printout of two consecutive layers with the use of the tested material, without crosslinking between the layers with an external lamp. The printouts were made on a BioX CELLINK printer. The printout follows the pattern in a 0°-90° system that reflects the 2D effect and increases the distance between fibres. The distance between fibres ranged from 1 to 5 mm, with a 1 mm increment. The print speed, needle diameter and extrusion width used for testing are 15 mm/s, 25G (0.250 mm) and 0.3 mm, respectively. During the test, the material was dosed at an appropriate pressure and temperature range, as in Table 3. The printout was subjected to additional crosslinking after each layer with an external UV-Vis lamp by Polbionica, with the following parameters: wave length 405 nm, time 30 s, power 28.5 mW/cm². Microscope photos were made after printing. They were processed with the ImageJ software. Based on the results, we determined two parameters defined with the following equations, i.e. the percent diffusion speed Dfr (material propagation speed) and printability Pr. The pore diffusion speed without material propagation is 0 (i.e. At=Aa), and the printability for an ideal model representation equals 1.0.

$${Df}_{r} = \frac{{A}_{t} - {A}_{a}}{{A}_{t}} \cdot 100 \%$$

$${P}_{r} = \frac{{L}^{2}}{16 \cdot {A}_{a}}$$

Aₜ—theoretical pore area,
Aₐ—actual pore area,
L—actual pore perimeter.

For each material variant, a printability of over 0.8 and a percent diffusion speed below 40% was achieved.
Diffusion speed declines, and printability increases, along with the growing size of pores.
The more viscous materials (1.5% (w/v) ALGMA and 2% (w/v) HAMA) show better printability parameters compared to their less viscous counterparts. These are also the materials that are most similar to the ideal material (Dfr=0, Pr=1).

### 2) Fibre Deflection Test

Deflection at half the span of a suspended fibre was analysed to determine the collapse of the material. To carry out the experiment, a special platform was designed consisting of seven pillars spaced at the known distances of 1, 2, 3, 4, 5 and 6 mm. The dimensions of five posts located inside the construct are 2×10×6 mm³, and the dimensions of two extreme posts are 5×10×6 mm³. A single fibre of the tested material was set on the platform according to the g-code: MR_test1.gcode, and then a photo of the printout was immediately taken. They were processed with the ImageJ software. In the meantime, temperature and pressure conditions were adjusted depending on the tested material, and the printout was made at a speed of 15 mm/s with the used of a 25 G (0.250 mm) needle. The collapse area coefficient Cf, i.e. the percentage of the actual area after deflecting the suspended fibre relative to the theoretical area.

$${C}_{f} = \frac{{A}_{a}^{c}}{{A}_{t}^{c}} \cdot 100 \%$$

Aₐ^{c}—theoretical area under the curve,
Aₜ^{c}—actual area under the curve.

### III. Biological Tests

Biological tests were conducted using blends of pre-crosslinked (Pre C-L) materials with the addition of low-concentration GELMA solution. The print parameters for each material are presented in Table 4. The applied parameters provided a uniform and compact fibre.

TABLE 4
Print parameters in printability tests

| | Pressure | Temperature | Speed |
|---|---|---|---|
| Variant | range [kPa] | [°C] | [mm/s] |
| 1.5% (w/v) HAMA_WS: 1% (w/v) | 25-40 | 20 | 15 |
| GELMA + 0.25% (w/v) LAP + L929 | | | |
| 3% (w/v) HAMA_WS: 1% (w/v) | 15-30 | 20 | 15 |
| GELMA + 0.25% (w/v) LAP + L929 | | | |
| 1.125% (w/v) ALGMA_WS: 1% (w/v) | 20-40 | 20 | 15 |
| GELMA + 0.25% (w/v) LAP + L929 | | | |
| 3% (w/v) ALGMA_WS: 1% (w/v) | 10-25 | 20 | 15 |
| GELMA + 0.25% (w/v) LAP + L929 | | | |

The biological tests included a viability test-FDA/Pi staining and a proliferation test with the use of an Alamar Blue reagent at selected time points: 0 hrs, 24 hrs, 72 hrs, 7 days, 14 days. The experiment covered biological tests performed on constructs populated with L929 cells and constructs containing L929 cells in material volume. Two constructs per each variant were printed out for the Alamar Blue proliferation test, and 5 construct per each variant for the PDA/Pi viability test.

The construct printed for the test had dimensions of 10×10×2 mm with 100% filling, according to the g-code file: 10×10×2×4_inf100.gcode. The construct from such initially prepared solutions were then crosslinked with a Polbionica UV-Vis lamp after each printout layer, with the following parameters: wave length 405 nm, time 30 s, power 28.5 mW/cm².

### IV. Results

### 1) Fibre Bonding Test

Three fibre bonding trials were performed for each material variant. Then microscope photos of the resulting constructs were taken-see FIG. 3. Based on the measurements, we calculated the percent fibre diffusion speed Dfr and the printability
Pr—the results are shown in the charts in FIG. 4-5).

### Conclusions

All the tested materials showed a continuous, compact fibre, which allowed making printouts of a good/very good resolution.
In none of the tested materials were we able to print out pores being 1×2 mm in size.
For each material variant, a printability of over 0.8 and a percent diffusion speed below 40% was achieved.
Diffusion speed declines, and printability increases, along with the growing size of pores.
The more viscous materials (1.5% (w/v) ALGMA and 2% (w/v) HAMA) show better printability parameters compared to their less viscous counterparts. These are also the materials that are most similar to the ideal material (Dfr=0, Pr=1).
The produced materials show much better printability parameters compared to solutions not subjected to pre-crosslinking.

### 2) Fibre Deflection Test

Three fibre deflection trials were performed for each material variant. Then photos of the resulting constructs were taken—see FIG. 6. Based on the measurements, we calculated the fibre collapse coefficient Cf, the results are shown in the charts in FIG. 7.

### Conclusions

All the tested materials showed a continuous, compact fibre, which allowed making printouts of a good/very good resolution.
For each of the tested variants, we printed out the fibre at the entire length of the platform, without any significant collapse of the fibre.
The fibre collapse coefficient shows a value below 80%.
The fibre collapse coefficient shows a similar value regardless of the spacing between consecutive posts of the test platform.
The more viscous materials (1.5% (w/v) ALGMA and 2% (w/v) HAMA) show better parameters in the fibre deflection tests compared to their less viscous counterparts. These are also the materials that are most similar to the ideal material (Cf=100).

The produced materials show much better printability parameters compared to solutions not subjected to pre-crosslinking.

Determining the Crosslinking Degree with the NMP Method

The determined crosslinking level depending on material irradiation time for 4% HAMA, 30-50 kDa, 405 nm, 28.5 mW/cm² and 2% HAMA, 130-300 kDa, 405 nm, 28.5 mW/cm². The results are shown in FIG. 8.

The determined crosslinking level depending on material irradiation time for 4% ALGMA, low viscosity, 405 nm, 28.5 mW/cm². The results are shown in FIG. 9.

The determined crosslinking level depending on material irradiation time for 3% GELMA, 405 nm, 28.5 mW/cm². The results are shown in FIG. 9.

### Alamar Blue Test

A quantitative method enabling a quantitative assessment of cell line proliferation degree. The reaction uses a colourant containing an oxidation and reduction indicator (REDOX) that both fluoresces and changes the colour in response to chemical reduction of growth medium due to the growth of cells. A continuous growth of live cells maintains a reducing (fluorescent, red) environment, while the inhibition of growth maintains an oxidised (non-fluorescent, blue) environment that can be detected with a fluorescence detector or absorbance.

### Biomaterial Designations:

1.5% (w/v) HAMA_WS (130-300 kDa): 1% (w/v) GELMA with the addition of 0.25% (w/v) LAP=2% HAMA+GELMA
3% (w/v) HAMA_WS (30-50 kDa): 1% (w/v) GELMA with the addition of 0.25% (w/v) LAP=4% HAMA+GELMA
3% (w/v) ALGMA_WS: 1% (w/v) GELMA with the addition of 0.25% (w/v) LAP=4% ALGMA+GELMA
1.125% (w/v) ALGMA_WS: 1% (w/v) GELMA with the addition of 0.25% (w/v) LAP=1.5% ALGMA+GELMA
4% (w/v) GELMA_WS+0.25% (w/v) LAP=4% GELMA

Comment on FIG. 11: the pre-crosslinking process does not affect the viability of cells suspended in hydrogel and subjected to 3D bio-printing with the extrusion method.

### Assessment of the Viability of L929 Cells Printed in the Tested Materials—Shown in FIGS. 13-18:

Both the cells subjected to printing and those being populated did proliferate in/on the tested biomaterials.

We observe a gradual growth of cells on days 1-7.

### Pre-Crosslinking to Improve HAMA Printability

### Procedure

### I. Preparing Solutions

### Solution HAMA 0.5-5%+LAP 0.0125%-2%

We prepared 20 ml of HAMA solution.

We moved 3 ml of PBS×1 by volume to a 5 ml flask using a pipette. We weighed out two LAP portions on a vessel of an analytical balance, and then properly moved them by volume to a flask with PBS×1 or another buffer appropriate for the material. The flask was wrapped with aluminium foil, moved to a thermoblock and shaken at a speed of 800 rpm and a temperature of 5-60° C. Once the photoinitiator was dissolved, the flasks were put in a refrigerator. We moved the PBS×1 or another appropriate buffer by volume to a 50 ml flask using a serological pipette. Then we weighed out two portions of HAMA lyophilizate and moved them to flasks with the PBS×1 or another stabilising buffer. The HAMA solutions were shaken in the thermoblock at a speed of 100-1200 rpm and a temperature of 10-50° C. for 0.1-1 hr. Once the HAMA was completely dissolved in the PBS×1, we moved 3 ml and 2 ml, respectively, of the dissolved photoinitiator solution to each flask. The HAMA solutions so prepared were shaken for the next 10 minutes until the components were combined.

### Preparing Pre-Crosslinked Materials

We used a syringe with a needle to collect 0.1-10 ml of HAMA solution and then sealed it with a blue protective plug. The syringe with the material inside was pre-crosslinked according to the parameters shows in Table 5. For this purpose, the syringe was placed under a Polbionica UV-Vis lamp. The material was crosslinked evenly by rotating the syringe by 180° at half the crosslinking time. After crosslinking, the syringe was protected against light by wrapping it with aluminium foil. The protected syringe was put aside to a thermoblock to stabilise the temperature (10° C.-30° C. depending on print variant) for 2-5 minutes. After that time, the pre-crosslinked solution was mixed in multiple syringes. The material so prepared was moved to a cartridge and used for printing.

TABLE 5
Overview parameters of HAMA solution pre-crosslinking
for a 405 nm wave length.

| | | | Wave | Stabilisation |
|---|---|---|---|---|
| | | Power | length | temperature |
| Variant | Time [s] | [mW/cm²] | [nm] | [°C] |
| 1 | 5 | 20.0 | 405 | 10 |
| 2A | 10 | 20.0 | 405 | 10 |
| 2B | 10 | 20.0 | 405 | 20 |
| 3 | 15 | 20.0 | 405 | 10 |
| 4 | 5 | 28.5 | 405 | 10 |
| 5 | 10 | 28.5 | 405 | 10 |
| 6 | 15 | 28.5 | 405 | 10 |

The material according to the foregoing procedure was pre-crosslinked at 1s-15s intervals for a time required to give them a printable form, that is for 1s-60s. The wave length used for pre-crosslinking covers a wave range of 250 nm-800 nm. The light power for the wave length of 365 nm and 405 nm ranges from 1 mW/cm² to 100 mW/cm²

### II. Printability Tests-Preliminary Tests

To assess printability with the prepared materials, 20×20 mm construct were printed out (2 layers×0.5 mm) with the use of two printing needles: 580 μm and 410 μm. The print parameters are shown in Table 6. Once the construct were printed out, their stability was assessed for whether they can be lifted from the pan without damage. In addition, a drop of pre-crosslinked solution was extruded for organoleptic assessment.

TABLE 6
Overview print parameters for selected variants.

| | | | | | Printing |
|---|---|---|---|---|---|
| | Initial | Print | | | needle |
| | resistance of | temperature | Print speed | Pressure | diameter |
| Variant | plunger [kPa] | [°C] | [mm/s] | [kPa] | [μm] |
| 1 | 8 | 10 | 20 | 36 | 580 |
| | | | | 53-55 | 410 |
| 2A | 8 | 10 | 20 | 48 | 580 |
| | | | | 56-61 | 410 |
| 2B | 5 | 20 | 20 | 44-47 | 580 |
| | | | | 57-62 | 410 |
| 3 | 9 | 10 | 20 | 58-60 | 580 |
| | | | | 91-95 | 410 |
| 4 | 8 | 10 | 20 | 33-35 | 580 |
| | | | | 50-53 | 410 |
| 5 | 5 | 10 | 20 | 54-57 | 580 |
| | | | | 63-65 | 410 |
| 6 | 5 | 10 | 20 | 69-72 | 580 |
| | | | | 73-76 | 410 |

The presented technology covers extrusion and volumetric printing as well as other printing technologies that require appropriate viscosity of the material to obtain a uniform and compact fibre to maintain the print resolution. The print temperature may vary from 5° C. to 50° C. depending on the material used. The print pressure for extrusion printing ranges from 5 to 150 kPa. Print speed in the range of 1-100 mm/s. Needle diameter in the range of 50-900 μm. The printed model can have any dimensions expressed in mm.

### Results

Overview printouts were made with the use of each prepared variant of the pre-crosslinked HAMA solution. The extruded fibres were compact, which allowed for printing at a good/very good resolution. A detailed description including photos is shown in FIGS. 20 and 21.

### FIG. 20:

1—Smooth, compact fibre, construct with a good resolution, construct could be lifted from the pan, they were not brittle, a compact and smooth drop
2—Smooth, slightly lumpy fibre, construct with a very good resolution, construct could be lifted from the pan, they were not brittle, a compact and smooth drop, small lumps visible.
3—No difference in fibre structure compared to the same parameters of pre-crosslinking at a lower printing temperature. Tight fibre, good extrusion.

### FIG. 21:

1—Very compact and slightly lumpy fibre. High print resolution. Clogging of a 410 μm needle. construct could be lifted from the pan, they were not brittle. Very compact drop.
2—Smooth, slightly compact fibre, construct with a good resolution. Construct could be lifted from the pan, they were not brittle. Compact and smooth drop.
3—Compact and slightly lumpy fibre. Good print resolution. Clogging of a 410 μm needle. Construct could be lifted from the pan, they were not brittle. Very compact drop.
4—Compact and slightly lumpy fibre. Very good print resolution. Clogging of a 410 μm needle. Construct could be lifted from the pan, they were not brittle. Very compact drop.

In addition, we compared the quality of extruded fibre of the pre-crosslinked material and the HAMA solution without crosslinking—see FIG. 22.

### Pre-Crosslinking to Improve ALGMA Printability

### Procedure

### I. Preparing Solutions

### Solution ALGMA 0.5-10%+LAP

We moved the PBS×1 by volume to a 50 ml flask using a pipette. Two LAP portions were weighed out on a vessel of an analytical balance and then properly moved by volume to a flask with PBS×1. The flask was wrapped with aluminium foil, moved to a thermoblock and shaken at a speed of 100-1200 rpm and a temperature of 5-50° C. Once the photoinitiator was dissolved, the flasks were put in a refrigerator. Then we weighed out a portion of ALGMA lyophilizate and moved it to a flask with the PBS×1 or another stabilising buffer. The ALGMA solutions were shaken in the thermoblock at a speed of 100-1200 rpm and a temperature of 5-50° C. for 0.1-4 hr. Once the ALGMA was completely dissolved, the flask was wrapped with aluminium foil and stored in a refrigerator.

### II. Preparing Pre-Crosslinked Materials

We prepared six 2.0 ml portions of ALGMA pre-crosslinked according to the SOP “Pre-crosslinking of methacrylate solutions”.

We used a syringe with a needle to collect 2 ml of the solution and then sealed it with a blue protective plug. The syringe with the material inside was pre-crosslinked according to the parameters shows in Table 7. For this purpose, the syringe was placed under a Polbionica UV-Vis lamp. The material was crosslinked evenly by rotating the syringe by 180° at half the crosslinking time. After crosslinking, the syringe was protected against light by wrapping it with aluminium foil. The protected syringe was put aside for 2-5 minutes. After that time, the pre-crosslinked solution was mixed in multiple syringes-10 pushes of the plunger. The material so prepared was moved to a cartridge and used for printing.

TABLE 7
Overview parameters of HAMA solution pre-crosslinking

| | | | Wave | Stabilisation |
|---|---|---|---|---|
| | | Power | length | temperature |
| Variant | Time [s] | [mW/cm²] | [nm] | [°C] |
| 1 | 10 | 20.0 | 405 | 20 |
| 2 | 40 | 20.0 | 405 | 20 |
| 3 | 40 | 28.5 | 405 | 20 |
| 4 | 30 | 28.5 | 405 | 20 |
| 5 | 60 | 20.0 | 405 | 20 |
| 6 | 60 | 28.5 | 405 | 20 |

### III. Printability Tests-Preliminary Tests

To assess printability with the prepared materials, 20×20 mm construct were printed out (2 layers×0.5 mm) with the use of two printing needles: 580 μm and 410 μm. The print parameters are shown in Table 8. Once the construct were printed out, their stability was assessed for whether they can be lifted from the pan without damage. In addition, a drop of pre-crosslinked solution was extruded for organoleptic assessment.

TABLE 8
Print parameters

| | | | | | Printing |
|---|---|---|---|---|---|
| | Initial | Print | | | needle |
| | resistance of | temperature | Print speed | Pressure | diameter |
| Variant | plunger [kPa] | [°C] | [mm/s] | [kPa] | [μm] |
| 1 | 8 | 20 | 20 | 8 | 580 |
| | | | | — | 410 |
| 2 | 4 | 20 | 20 | 13 | 580 |
| | | | | 25-28 | 410 |
| 3 | 5 | 20 | 20 | 23 | 580 |
| | | | | 35 | 410 |
| 4 | 8 | 20 | 20 | 13 | 580 |
| | | | | 21 | 410 |
| 5 | 5 | 20 | 20 | 29-31 | 580 |
| | | | | 45-49 | 410 |
| 6 | 5 | 20 | 20 | 39-41 | 580 |
| | | | | 51-56 | 410 |

The material according to the foregoing procedure was pre-crosslinked at 1s-15s intervals for a time required to give them a printable form, that is for 1s-60s. The wave length used for pre-crosslinking covers a wave range of 250 nm-800 nm. The light power for the wave length of 365 nm and 405 nm ranges from 1 mW/cm² to 100 mW/cm².

### Results

A printout was made with the use of each prepared variant of the pre-crosslinked ALGMA solution. The ALGMA solution requires a longer pre-crosslinking time (compared to the HAMA solution) to obtain a fibre compact enough to print out a model with a good/very good resolution. A detailed description including pictures is shown in FIGS. 26 and 27.

### FIG. 26:

1—Smooth, highly flowing fibre. Producing a good-resolution construct impossible.
2—Fibre slightly flowing but allows for producing a construct with average/good resolution. Needles not clogging. Drop slightly fluid. Construct flexible, can be taken off the pan.
3—Compact and slightly extending. Construct with a very good resolution. Needles not clogging. Compact and smooth drop. Construct flexible, can be taken off the pan.

### FIG. 27:

1—Fibre slightly fluid but allows for producing a construct with average/good resolution. Needles not clogging. Drop slightly fluid. Construct flexible, can be taken off the pan.
2—Compact and slightly lumpy fibre, construct with a very good resolution. Needles not clogging. Construct flexible, can be taken off the pan. Compact and smooth drop.
3—Compact and slightly lumpy fibre, construct with a very good resolution. Needles not clogging. Construct flexible, can be taken off the pan. Compact and smooth drop.

The presented technology covers extrusion and volumetric printing as well as other printing technologies that require appropriate viscosity of the material to obtain a uniform and compact fibre to maintain the print resolution. The print temperature may vary from 5° C. to 50° C. depending on the material used. The print pressure for extrusion printing ranges from 5 to 150 kPa. Print speed in the range of 1-100 mm/s. Needle diameter in the range of 50-900 μm. The printed model can have any dimensions expressed in mm.

The technology involves the use of any materials based on functionalised derivatives of natural-origin polymers that may be subject to partial and/or full polymerisation or crosslinking in the course of other chemical conversions, which are carried out by way of forming covalent bonds. The factor that initiates crosslinking is the UV-Vis light acting directly on the material or initiating decomposition of the photoinitiator. The polymers must show a significant or complete solubility in water environment at the concentration range of 0.1-40%. This technique can be applied for polymer solutions with a low viscosity that makes it impossible to produce a printout with a high resolution and fibre homogeneity. Crosslinking induces the increase in the molecular weight of the applied polymer and its subsequent changes in mechanical properties of hydrogels, which are manifested in increased material viscosity. Pre-crosslinking thus makes it possible to print out a material at low concentration limits. A schematic diagram describing the whole process is presented in FIG. 19.

The proposed technology of pre-crosslinking a material should be fully measurable for determining the material crosslinking degree in a range that allows for expressing it as a percentage of groups that can be crosslinked. The material crosslinking degree should range between 0.1% and 99% of the loss of functional groups that can be crosslinked.

1. A process for pre-crosslinking methacrylates comprising the following steps:
placing in a transparent vessel an aqueous solution with pH 4 to 8 comprising a methacrylate with a molecular weight of 1 kDa to 500,000 kDa, preferably 30 to 70 kDa, with a number of functional groups subject to polymerisation of at least 0.5% and a concentration ranging from 0.5 to 50% (w/v), and a photoinitiator with a concentration ranging from 0.0125% to 2% (w/v),
the mixture is subjected to UV-VIS irradiation UV-VIS with a wave length of 250 nm to 800 nm and a power of 1 to 1000 mW/cm², for a time not exceeding 1000 S,
wherein the vessel is rotated by 180 degrees at half the crosslinking time,
wherein the crosslinking is carried out in a syringe with a cross-section of 1 to 100 nm.

2. The process according to claim 1, characterised in that the methacrylates are selected from a group consisting of GELMA, HAMA, ALGMA, CHIMA

3. The process according to claim 1, characterised in that the photoinitiator is selected From a group including lithium phenyl-2,4,6-trimethylbenzoylphosphine, 2-Hydroxy-1-(4-(2-hydroxyethoxy)phenyl)-2-methylpropan-1-one and its derivatives or the derivatives of diazo compounds.

4. The process according to claim 1, characterised in that the aqueous solution is a physiological salt, a cellular medium or a weak acid solution.

5. A bio-ink composition comprising a pre-crosslinked methacrylate, obtained by the process according to claims 1 to 5,
characterised in that the pre-crosslinked methacrylate has a conversion degree expressed as the content of converted methacrylate groups or other groups subject to polymerisation, which ranges from 0.1% to 99.9%,
preferably from 40 to 60% and
a pre-crosslinked methacrylate with a concentration of 0.5% to 50% (w/v) and
a non-crosslinked methacrylate with a concentration of 0.1% to 99.9% (w/v).

6. The composition according to claim 5 which additionally comprises L929 cells in a number of not less than 5×10⁵ per millilitre of bio-ink composition.

7. Use of the composition according to claim 5 for bio-printing.

8. The use according to claim 7, characterised in that the printing temperature ranges from 5 to 50° C., the pressure ranges from 5 to 150 kPa, the printing speed ranges from 1 to 100 mm/s, and the needle diameter ranges from 50 to 900 μm, wherein once the printing is completed, an additional portion of UV-VIS light is applied with a wave length ranging from 280 nm to 800 nm, preferably 405 nm, for a time of 1 s to 360 s, preferably 30 s, with a power of 1 to 1000 mW/cm², preferably 28.5 mW/cm² 405 nm, time 30 s, with a power of 28.5 mW/cm².

9. The use according to claim 7 or 8, characterised in that the printing includes extrusion or volumetric print.
